(19) United States
(12) Patent Application Publication
(10) Pub. No.: US 2007/0179749 A1
(43) Pub. Date: Aug. 2, 2007

(54) Portable measuring device for use in sport

(76) Inventor: Franck Landrieve, Fondettes (FR)

Correspondence Address: MEYERTONS, HOOD, KIVLIN, KOWERT & GOETZEL, P.C., P.O. BOX 398, AUSTIN, TX, 78767-0398, US

(21) Appl. No.: 10/551,167

(22) PCT Filed: Mar. 12, 2004
(86) PCT No.: PCT/FR04/00602

§ 371 Date: Jul. 3, 2006

(30) Foreign Application Priority Data
Mar. 27, 2003 (FR) 03/03781

(51) Int. Cl. G06F 19/00

(52) U.S. Cl. 702/188

(57) ABSTRACT

A portable measuring device for use in sport may include a housing provided with a sensor, a receiver, emitter, and a processing unit. The housing may transmit signals from the sensor of the housing to a remote display and may act as relay, receiving signals from a remote detector worn by a user and re-emitting the signals to the remote display.

### BACKGROUND OF THE INVENTION

1. Field of the Invention

The present invention relates to a portable measuring instrument, particularly for use in sport.

2. Description of the Relevant Art

In sport it is possible to use measuring instruments of the pedometer or cardiofrequencymeter type, which are generally provided with suitable sensors and display screens for reading the measurements taken. Such devices are provided for a unique use and do not allow a different use, possibly in association with other measuring means, for a same sport or for a different sport.

### SUMMARY

A multi-purpose portable measuring instrument for use in sport may include a sensor, in particular an accelerometer in order to form a pedometer. The multi-purpose portable measuring instrument may be adapted for use in association with other remote measuring means.

Such a portable measuring instrument, particularly for use in sport, may include a housing provided with a sensor, a receiver, a transmitter, and a processing unit. The housing, intended to be worn by a user, is adapted to transmit signals coming from the housing's sensor to a remote display, intended to be worn by a user, and to function as a relay by receiving signals coming from a remote detector, intended to be worn by a user, and retransmitting these signals to the remote display. The housing provided with a sensor makes it possible to take measurements relating to the practice of a sport. The housing makes it possible to transmit, remotely, signals from the housing disposed in an appropriate measuring place to the display disposed at a convenient place for easy reading. Moreover, the housing adapted to function as a relay transmitter makes it possible to provide a detector worn by the user and at an appropriate measuring place remote from the housing and from the display, to receive signals from the detector and to retransmit them in an appropriate way to the remote display for easy reading. Advantageously, the housing may include an accelerometer. In this case the housing can be provided with processing means connected to the accelerometer, these means being adapted to form a pedometer.

In one embodiment, the housing may include a display screen. Data encoded by signals coming from remote devices or from the accelerometer can be displayed directly on the housing. A housing forming a pedometer can be adapted to display data associated with the pedometer directly on the display screen or to transmit this data to a remote display.

In some embodiments, the processing unit is able to provide a secondary signal encoding a measurement signal and a secondary identification code. The addition of a secondary identification code to the measurement signal before transmission of the secondary signal makes it possible to avoid interference during radio transmissions.

In one embodiment, the instrument may include a remote display including a display screen and a secondary receiver. The display may include a secondary processing stage able to identify a secondary signal according to a secondary identification code inserted in a frame of the secondary signal. In one embodiment, the instrument may include a remote detector including a sensor and a primary transmitter. Signals encoding measurements coming from the sensor can be transmitted to the housing by the primary transmitter. The data encoded by the signal can be displayed directly on the housing or retransmitted to a remote display. Advantageously, the detector may include a processing stage able to provide a primary signal encoding a measurement signal of the sensor and a primary identification code.

In an embodiment, the housing is provided with detachable fixing components. A display can be worn by the user directly or can be disposed on a part of the user's equipment, such as the frame of a cycle, using appropriate fixing means.

### BRIEF DESCRIPTION OF THE DRAWINGS

The present invention and its advantages will be better understood on studying the detailed description of embodiments taken as examples that are in no way limiting and illustrated by the appended drawings in which:

FIG. 1 is a general diagrammatic view of a skater using a portable measuring instrument according to one embodiment;

FIG. 2 is a diagrammatic view of a roller skate boot provided with a measuring instrument according to one embodiment;

FIG. 3 is a top view of a housing according to one embodiment;

FIG. 4 is a functional block diagram of the portable measuring instrument according to one embodiment;

FIG. 5 shows a roller skate boot provided with a measuring instrument according to an embodiment; and

FIG. 6 is a top view of a measuring instrument according to FIG. 5.

### DETAILED DESCRIPTION OF EMBODIMENTS

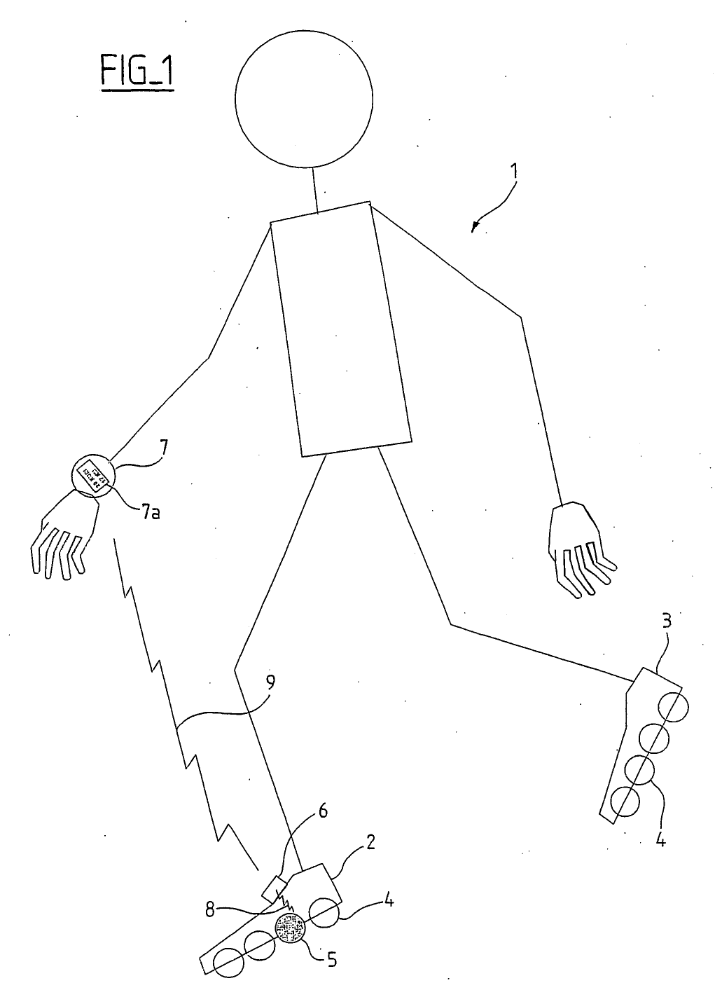

In FIG. 1, a skater 1 is wearing roller skate boots 2, 3 fitted with wheels 4 disposed in lines. A roller skate 2 may include an instrumented wheel 5, shown shaded in FIG. 1, provided with a detector (not shown) including a sensor able to provide a measuring signal representing at least one rotation parameter of the instrumented wheel 5, and with a primary transmitter for transmitting primary signals corresponding to the measurements. A housing 6 is fixed to the top of the roller skate boot 2. The skater 1 wears a display 7 on his wrist provided with a wrist-strap (not visible) and a data display screen 7a. As represented by the jagged lines 8, 9, the housing 6 can receive primary radio signals transmitted by the primary transmitter of the detector of the instrumented wheel 5, and the display 7 can receive secondary radio signals transmitted by the relay housing 6.

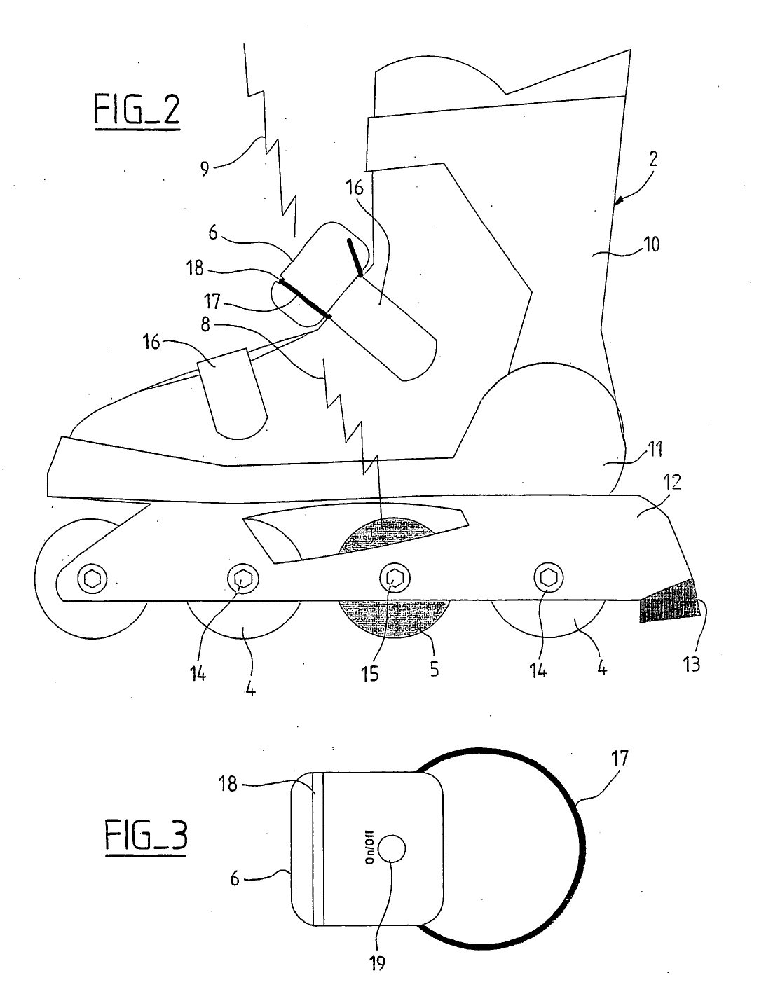

In FIG. 2, the skate 2 may include a show or boot 10 under the sole 11 of which is fixed a blade 12 provided at its rear end with a brake 13 and supporting wheels 4, four of them in this case, disposed in line and each fixed to the blade 12 by the intermediary of a spindle 14. An instrumented wheel 5, shaded in FIG. 2, is provided with a detector (not shown) provided in the form of a sensor and with a primary transmitter and carried by spindle for fixing the instrumented wheel 5, such that it can rotate, on the blade 12. More details relating to the structure and fitting of the spindle 15 and of the instrumented wheel 5 and the disposition of the detector, are disclosed in FR 2 820 476.

The boot 10 may include means of closing and tightening in the form of flaps 16. A housing 6 is disposed on the top of the boot 10, at the kicking point, and fixed to one of the flaps 16. Housing 6 may include an elastic band 17 which is passed under the flap 16 whilst stretched and slipped into a groove 18 provided on the face of the housing 6 opposite to the one facing the boot 10. Thus, the elastic band 17 holds the housing 6 on the boot 10. The groove 18 makes it possible to hold the elastic band 17 in position. The groove 18 has a suitable cross-sectional profile to retain the elastic band 17 stretched and wound around an element on the side of the housing 6 opposite to the groove 18, the end of the elastic band 17 being brought up to and slipped into the groove 18.

In FIG. 3, the housing 6 is shown unfixed. The housing 6 is provided on its upper face with the groove 18 and with an on-off power button 19. The housing 6 also may include the elastic band 17 fixed to the housing 6 at a distance from the groove 18. The housing 6 may be powered in a way known to one skilled in the art, such as using a battery or an accumulator.

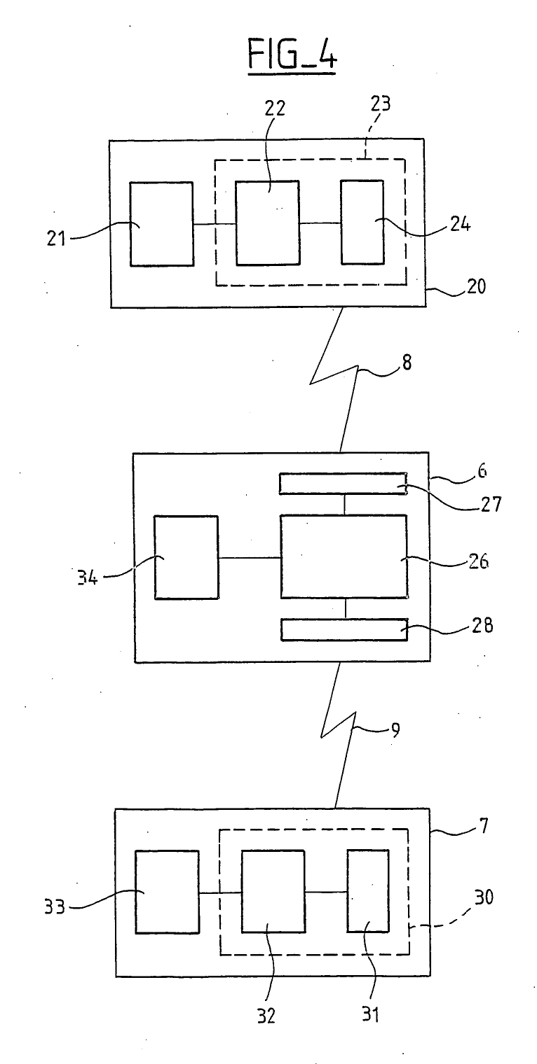

In FIG. 4, the measuring instrument may include a detector 20 housed in a wheel or mounted on a fixing element of a wheel, a housing 6, and a display 7, which are distant from each other. A detector may be mounted on a rotational spindle of a wheel. The detector 20 may include a sensor 21, connected to a processing stage 22 of a primary radio transmitter 23, itself connected to a radio antenna 24 of the primary transmitter 23.

The housing 6 may include a processing unit 26 connected to a primary radio receiver 27 in the form of a receiving antenna, and to a secondary radio transmitter 28 in the form of a transmitting antenna. The processing unit 26 may include a microprocessor (not shown) and memory means (not shown) in which is stored at least one program able to be used by the microprocessor.

The relay housing 6 also may include an accelerometer 34 connected to the processing unit 26. The accelerometer 34 may be associated with appropriate processing software stored in the memory means of the processing unit 26 and able to be used by the microprocessor of the unit 26. The accelerometer 34 makes it possible to obtain a pedometer.

The display 7 may include a secondary radio receiver 30, including a secondary receiving antenna 31 connected to a secondary processing stage 32 of the secondary receiver 30. The secondary receiver 30 may be connected to a display device 33, which can be, for example, a liquid crystal display screen.

The housing 6 can operate in pedometer mode or in relay mode. When the housing 6 operates in relay mode, the sensor 21 transmits an analog measuring signal which is transmitted to the primary processing stage 22 which provides, periodically or continuously, a primary digital signal encoding the measurement signal and a primary identification code. With the processing stage 22 forming a radio circuit for the antenna 24, the primary signal is applied to the primary antenna 24 which transmits a radio frequency wave represented diagrammatically by a jagged line 8.

The radio frequency wave 8 may be received by the primary receiver 27 of the housing 6 and transmits to the processing unit 26 which can identify the said primary signal as coming from the detector 20 associated with the relay housing 26 by means of the primary identification code of the primary signal. If the primary identification code is validated, the processing unit 26 extracts the frame encoding the measurement signal from the primary signal, and forms a secondary digital signal encoding the measurement signal and a secondary identification code.

The processing unit 26 forming a radio circuit for the secondary transmitter 28 causes the transmission of a radio wave represented diagrammatically by a jagged line 9. The secondary receiving antenna 31 of the display 7 receives the radio wave 9. The secondary processing stage 32 identifies the signal by means of the secondary identification code. If the signal is validated as coming from the intermediate housing 25 associated with the display 29, the processing stage 32 extracts the measurement signal and transmits to the display device 33 a signal for the display of data corresponding to the initial measurement signal provided by the sensor 21.

When the housing 6 is operating as a pedometer, it may be fixed to a lower member of the person or on a walking shoe. The accelerometer 34 transmits measurements signals to the processing unit 26 which causes the transmission of a secondary signal encoding the accelerometer measurement signal and a secondary identification code, the secondary signal being transmitted by the secondary transmitter 28 to the display 7. The user, provided with the display 7, can thus determine a number of steps taken. Processing operations on measurement signals for the purpose of converting them into values meaningful to the user (distance traveled, instantaneous speed, average speed), can be carried out by the processing stage of the detector 20 and preferably by the processing unit 26 of the housing 6 or the processing stage 32 of the display 7, which can be used independently of the detector during use as a pedometer.

The use of primary and secondary identification codes makes it possible to prevent any interference of radio transmissions by a similar system used in the vicinity. In an embodiment, a radio signal received by the primary receiver 27 or the secondary receiver 30 and not including an appropriate identification code will not be processed. Moreover, the use of different primary and secondary identification codes makes it possible to avoid interference between the secondary and primary radio transmissions.

As in FIGS. 1 and 2, the housing is close to the instrumented wheel. Consequently, it is possible to provide a primary transmitter adapted for the transmission of radio waves over shorter distances. The power necessary for the transmission of radio waves by the primary transmitter is therefore low. The risk of items being interposed between the primary transmitter and the primary receiver of the housing 6 is low. On the other hand, the distance between the housing and the display is greater. However, the antenna of the secondary transmitter of the housing can be provided with larger dimensions than those of the antenna of the primary transmitter because the space available is not limited. In an embodiment, the antenna of the secondary transmitter is free of any metal parts able to impede the transmission of radio waves. The reception by the display is thus improved.

In some embodiments, the housing 6 can be provided with a selection button, not shown, for operation in pedometer mode or in relay mode.

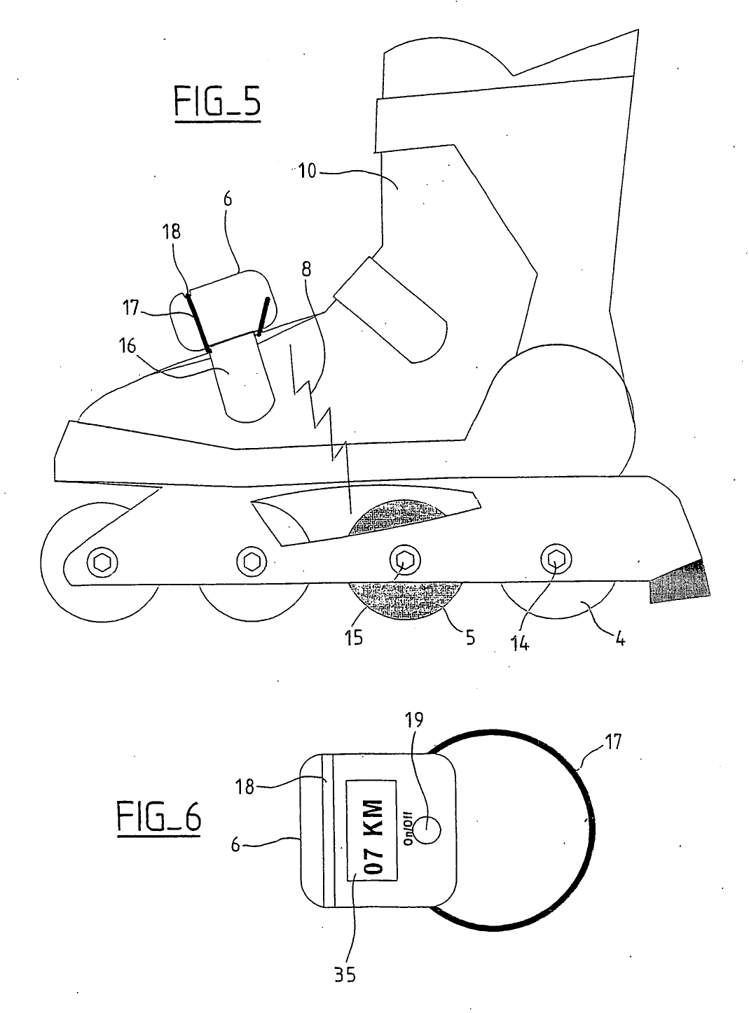

In FIGS. 5 and 6, the housing 6 is furthermore provided with a display screen 35 (FIG. 6). As shown in FIG. 5, the housing 6 can be disposed at the front of the boot 10, by being fixed to a tightening flap 16, in order to facilitate reading by the skater. The housing 6 makes it possible to display directly the data received by the primary receiver (not visible) coming from the detector (not visible) housed in the instrumented wheel 5, or the data corresponding to the measurements of the accelerometer. In pedometer mode, the housing 6 can be fixed to a boot or onto a member of the body, such as the legs or the arms.

A use of the measuring instrument in association with a detector housed in a wheel of a roller skate has been described as a non-limiting example. It is possible to envisage applications to skateboards or cycles. The measuring instrument can be used with any type of detector, provided that the detector is provided with a transmitter for the transmission of the measurement signals to the housing of the measuring instrument. Accelerometers have been mentioned, but other types of sensors could be provided.

In some embodiments, a measuring instrument is obtained for use in sport that allows the reception of measurement signals coming from a remote detector. The measurement signals can be displayed directly or transmitted to a remote display, in which case the measuring instrument allows a communication relay in order to improve the quality of the communications.

1. A portable measuring instrument, particularly for use in sport, comprising:
a housing comprising:
a sensor;
a receiver;
a transmitter; and
a processing unit;
wherein the housing is adapted to transmit signals coming from the sensor to the housing intended to be worn by a user, and wherein the housing functions as a relay by receiving signals coming from a remote detector intended to be worn by a user and retransmitting these signals to the housing.

2. The instrument of claim 1, wherein the housing comprises an accelerometer.

3. The instrument of claim 2, wherein the housing further comprises a processing means connected to the accelerometer, and wherein the processing means is adapted to form a pedometer.

4. The instrument of claim 1, wherein the housing comprises a display screen.

5. The instrument of claim 3, wherein the housing is adapted to display data associated with the pedometer directly on the display screen or transmit the data to a remote display.

6. The instrument of claim 1, wherein the processing unit is able to provide a secondary signal encoding a measurement signal and a secondary identification code.

7. The instrument of claim 1, further comprising a remote display comprising:
a display screen; and
a secondary receiver.

8. The instrument of claim 7, wherein the display comprises a secondary processing stage able to identify a secondary signal according to a secondary identification code inserted in a frame of the secondary signal.

9. The instrument of claim 1, further comprising a remote detector comprising:
a sensor; and
a primary transmitter.

10. The instrument of claim 9, wherein the detector comprises a processing stage able to provide a primary signal encoding a measurement signal of the sensor and a primary identification code.

11. The instrument of claim 1, wherein the housing comprises detachable fixing components.

12. The instrument of claim 7, wherein the display is provided with means of fixing directly on the user or on a part of the user's equipment, such as the frame of a cycle.

13. The instrument of claim 5, wherein the processing unit is able to provide a secondary signal encoding a measurement signal and a secondary identification code.

14. The instrument of claim 7, further comprising a remote detector comprising:
a sensor; and
a primary transmitter.

15. The instrument of claim 14, wherein the detector comprises a processing stage able to provide a primary signal encoding a measurement signal of the sensor and a primary identification code.

16. The instrument of claim 8, wherein the display is provided with means of fixing directly on the user and on a part of the user's equipment, such as the frame of a cycle.
